(19) United States
(12) Patent Application Publication
(10) Pub. No.: US 2014/0137410 A1
(43) Pub. Date: May 22, 2014

(54) THERMAL MODULE STRUCTURE AND MANUFACTURING METHOD THEREOF

(71) Applicant: Asia Vital Components Co., Ltd., New Taipei City (TW)

(72) Inventor: Chun-Ming Wu, New Taipei City (TW)

(73) Assignee: Asia Vital Components Co., Ltd., New Taipei City (TW)

(21) Appl. No.: 14/163,461

(22) Filed: Jan. 24, 2014

Related U.S. Application Data
(62) Division of application No. 13/186,446, filed on Jul. 19, 2011.

(51) Int. Cl. B23P 15/26

(52) U.S. Cl. CPC B23P 15/26
USPC 29/890.032

(57) ABSTRACT

A thermal module structure and a manufacturing method thereof. The thermal module structure includes a base and a heat pipe. The base has a first channel and a first recessed section in communication with the first channel. The heat pipe is correspondingly disposed in the first channel. According to the thermal module structure, the heat pipe can directly contact heat source and directly connect with the base without brazing. Therefore, the manufacturing cost is greatly lowered.

### BACKGROUND OF THE INVENTION

1. Field of the Invention

The present invention relates generally to a thermal module structure and a manufacturing method thereof. The thermal module structure includes a base and a heat pipe. According to the manufacturing method, the heat pipe can be directly assembled with the base to contact heat source without the conventional brazing process.

2. Description of the Related Art

A conventional heat dissipation device or thermal module is composed of multiple heat dissipation components assembled with each other. The heat dissipation components are heat pipes, heat sinks, heat dissipation bases, etc. These heat dissipation components are generally fixedly connected with each other by means of brazing. However, as to aluminum-made heat dissipation components, it is necessary to use specific brazing means for brazing the heat dissipation components with each other. This leads to increase of manufacturing cost.

Alternatively, the heat dissipation components can be fixedly connected by means of fastening members such as screws. However, the fastening members can be only used to lock some heat dissipation components (such as radiating fin assembly and heat dissipation base), while it is impossible to use screws to fix the heat pipe.

Moreover, in the conventional technique, the heat dissipation base is formed with a perforation or a channel. The heat pipe is fitted through the perforation or the channel to connect with the heat dissipation base. This can solve the above problems caused by the brazing process or screws. However, a gap exists between the heat pipe and the heat dissipation base to lead to thermal resistance against transfer from the heat dissipation base to the heat pipe. Under such circumstance, the heat can be hardly efficiently conducted from the heat dissipation base to the heat pipe.

According to the above, the heat dissipation components of the conventional thermal module can be hardly optimally assembled to provide better heat dissipation effect. Therefore, the conventional thermal module has the following shortcomings:

1. The manufacturing cost of the conventional thermal module is higher.

2. The heat dissipation components of the conventional thermal module can be hardly optimally assembled.

3. The heat conduction efficiency of the conventional thermal module is poor.

### SUMMARY OF THE INVENTION

A primary object of the present invention is to provide a thermal module structure in which the heat dissipation components can be more flexibly assembled.

A further object of the present invention is to provide the above thermal module structure, which has better heat conduction efficiency.

A still further object of the present invention is to provide a manufacturing method of a thermal module structure. By means of the manufacturing method, the heat dissipation components of the thermal module structure can be more flexibly assembled and the thermal module structure can provide better heat conduction effect.

To achieve the above and other objects, the thermal module structure of the present invention includes a base and at least one heat pipe. The base has a first side, a second side and at least one first channel. The first side is formed with a first recessed section in communication with the first channel.

The heat pipe has a first face and a second face. The heat pipe is correspondingly disposed in the first channel.

The manufacturing method of the thermal module structure of the present invention includes steps of:

preparing at least one heat pipe and a base having at least one channel and a board body;

correspondingly disposing the heat pipe into the channel of the base; and

forming a recessed section on one side of the base opposite to the channel by means of mechanical processing, the recessed section being in communication with the channel.

By means of the manufacturing method of the thermal module structure of the present invention, the heat dissipation components of the thermal module structure can be more flexibly assembled and the thermal module structure can provide better heat conduction effect.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein:

FIG. 1 is a perspective exploded view of a first embodiment of the thermal module structure of the present invention;

FIG. 2 is a perspective assembled view of the first embodiment of the thermal module structure of the present invention;

FIG. 3 is a side view of a second embodiment of the thermal module structure of the present invention;

FIG. 4 is a perspective assembled view of a third embodiment of the thermal module structure of the present invention;

FIG. 5 is a perspective exploded view of a fourth embodiment of the thermal module structure of the present invention;

FIG. 6 is a perspective assembled view of the fourth embodiment of the thermal module structure of the present invention;

FIG. 7 is a perspective exploded view of a fifth embodiment of the thermal module structure of the present invention;

FIG. 8 is a perspective assembled view of the fifth embodiment of the thermal module structure of the present invention;

FIG. 9 is a perspective exploded view of a sixth embodiment of the thermal module structure of the present invention;

FIG. 10 is a perspective exploded view of a seventh embodiment of the thermal module structure of the present invention;

FIG. 11 is a flow chart of a first embodiment of the manufacturing method of the thermal module structure of the present invention;

FIG. 12 is a flow chart of a second embodiment of the manufacturing method of the thermal module structure of the present invention; and

FIG. 13 shows the application of the thermal module structure of the present invention.

### DETAILED DESCRIPTION OF THE PREFERRED EMBODIMENTS

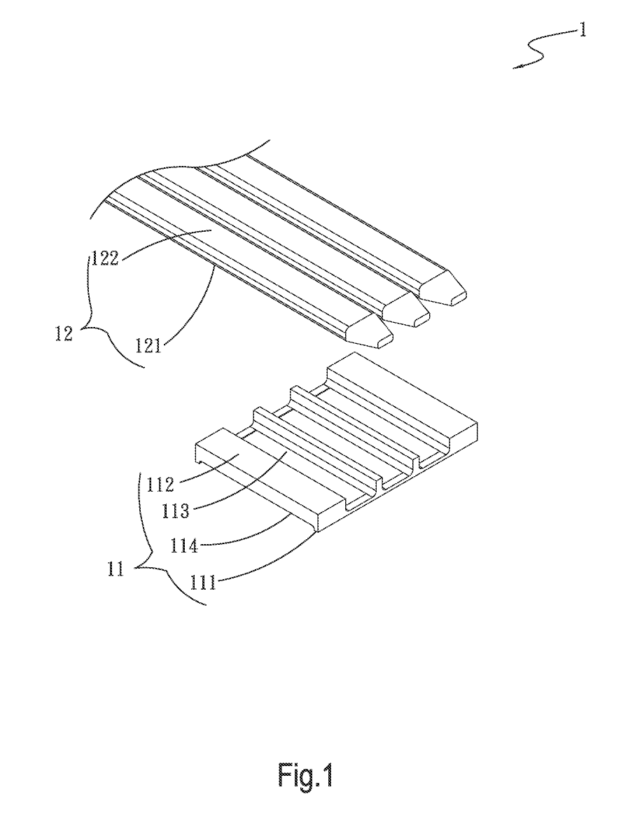

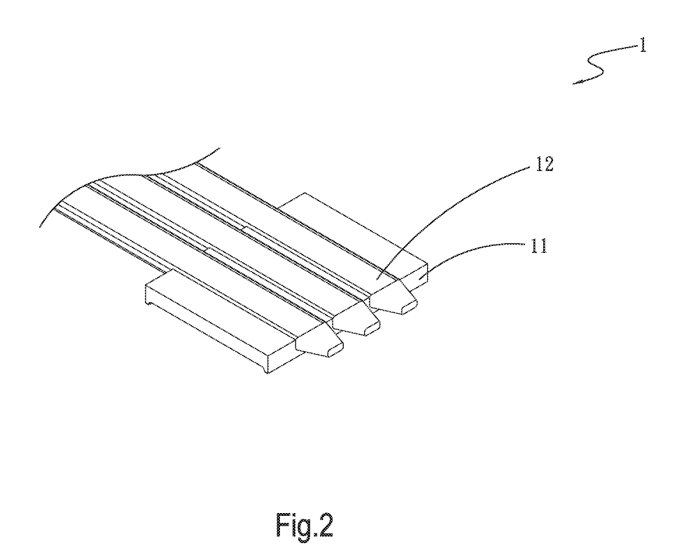

Please refer to FIGS. 1 and 2. FIG. 1 is a perspective exploded view of a first embodiment of the thermal module structure of the present invention. FIG. 2 is a perspective assembled view of the first embodiment of the thermal module structure of the present invention. According to the first embodiment, the thermal module structure 1 of the present invention includes a base 11 and at least one heat pipe 12.

The base 11 has a first side 111, a second side 112 and at least one first channel 113. The first side 111 is formed with a first recessed section 114 in communication with the first channel 113.

The heat pipe 12 has a first face 121 and a second face 122. The heat pipe 12 is correspondingly disposed in the first channel 113 with the first face 121 flush with the bottom of the first channel 113.

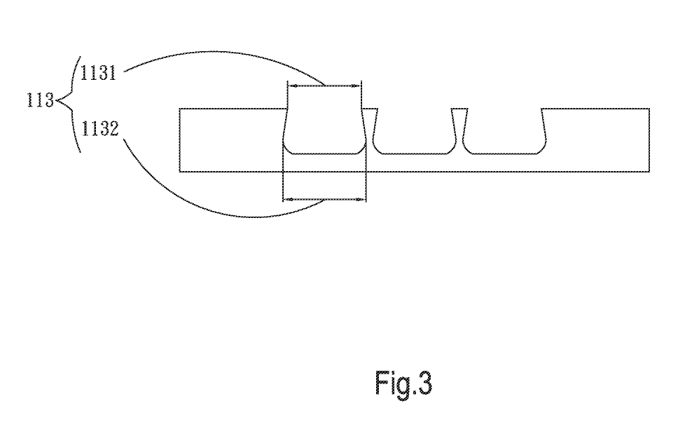

Please refer to FIG. 3. FIG. 3 is a side view of a second embodiment of the thermal module structure of the present invention. The second embodiment is substantially identical to the first embodiment in structure and thus will not be repeatedly described hereinafter. The second embodiment is only different from the first embodiment in that in the second embodiment, the first channel 113 has an open side 1131 and a closed side 1132. The open side 1131 has a width smaller than that of the closed side 1132.

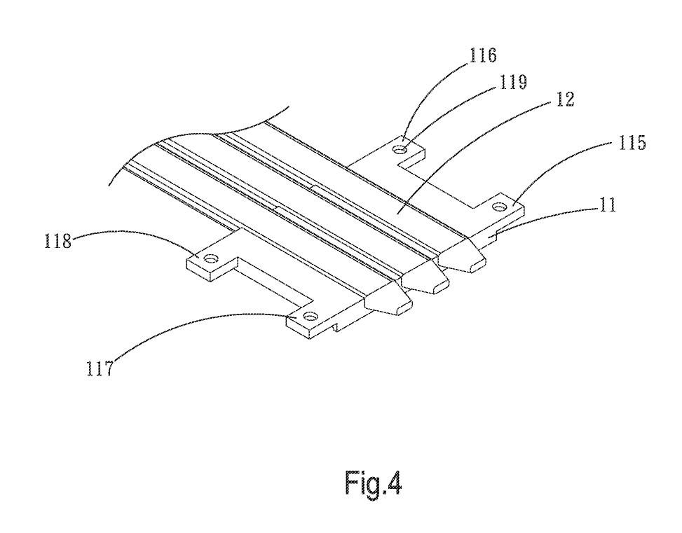

Please refer to FIG. 4. FIG. 4 is a perspective assembled view of a third embodiment of the thermal module structure of the present invention. The third embodiment is substantially identical to the first embodiment in structure and thus will not be repeatedly described hereinafter. The third embodiment is only different from the first embodiment in that in the third embodiment, the base 11 further has a first extension section 115, a second extension section 116, a third extension section 117 and a fourth extension section 118. Each of the extension sections 115, 116, 117, 118 has at least one perforation 119.

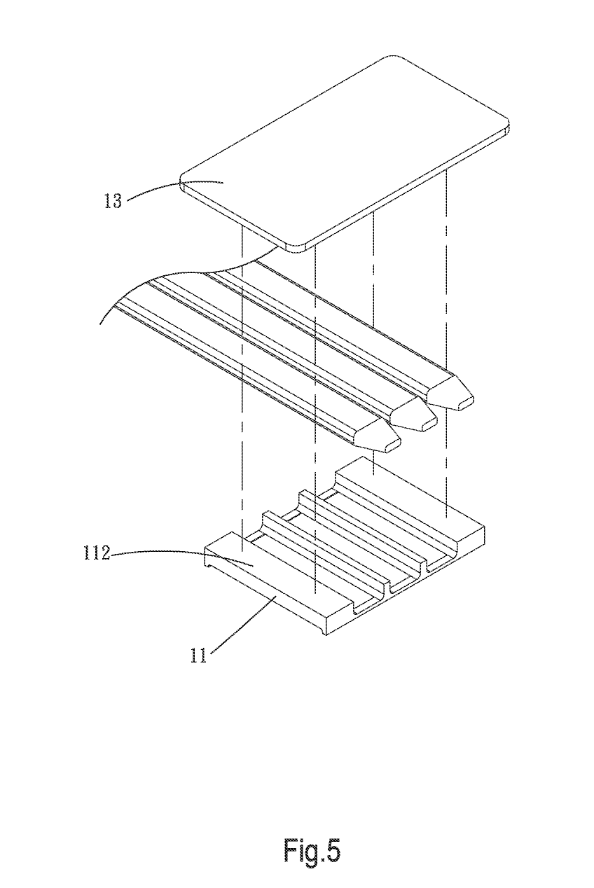

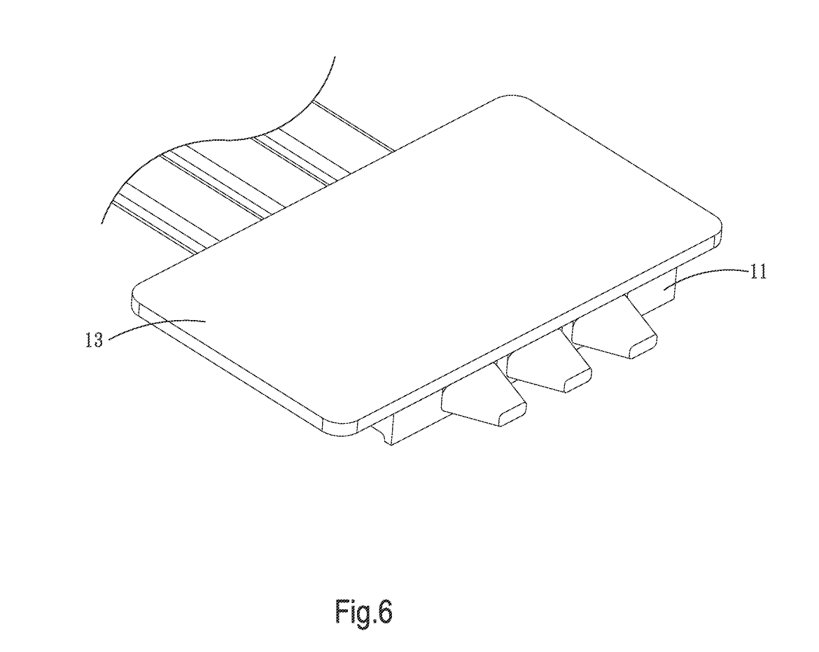

Please refer to FIGS. 5 and 6. FIG. 5 is a perspective exploded view of a fourth embodiment of the thermal module structure of the present invention. FIG. 6 is a perspective assembled view of the fourth embodiment of the thermal module structure of the present invention. The fourth embodiment is substantially identical to the first embodiment in structure and thus will not be repeatedly described hereinafter. The fourth embodiment is only different from the first embodiment in that the fourth embodiment further includes a board body 13 attached to the second side 112 of the base 11.

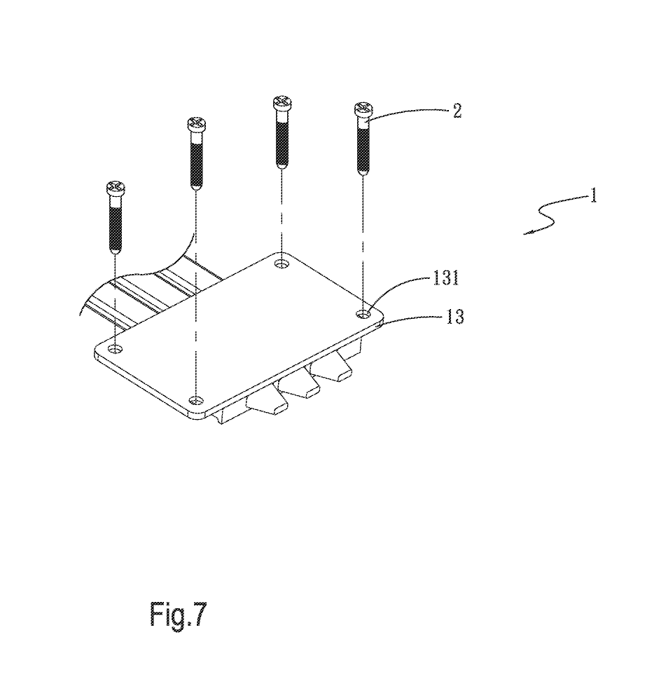

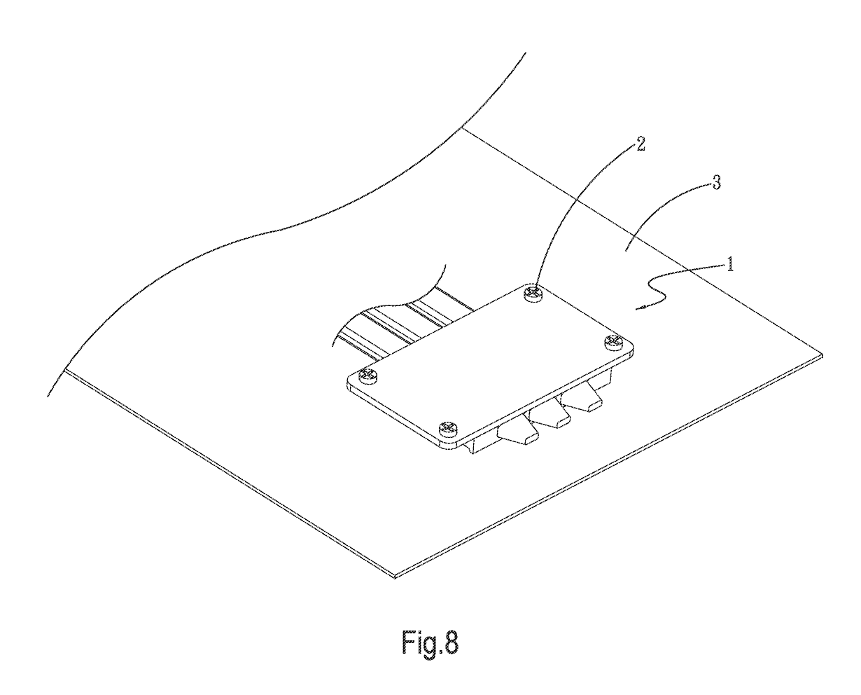

Please refer to FIGS. 7 and 8. FIG. 7 is a perspective exploded view of a fifth embodiment of the thermal module structure of the present invention. FIG. 8 is a perspective assembled view of the fifth embodiment of the thermal module structure of the present invention. The fifth embodiment is substantially identical to the fourth embodiment in structure and thus will not be repeatedly described hereinafter. The fifth embodiment is only different from the fourth embodiment in that in the fifth embodiment, at least one hole 131 is formed on each of four corners of the board body 13. Fastening members 2 can be passed through the holes 131 to fix the board body 13 with a substrate 3.

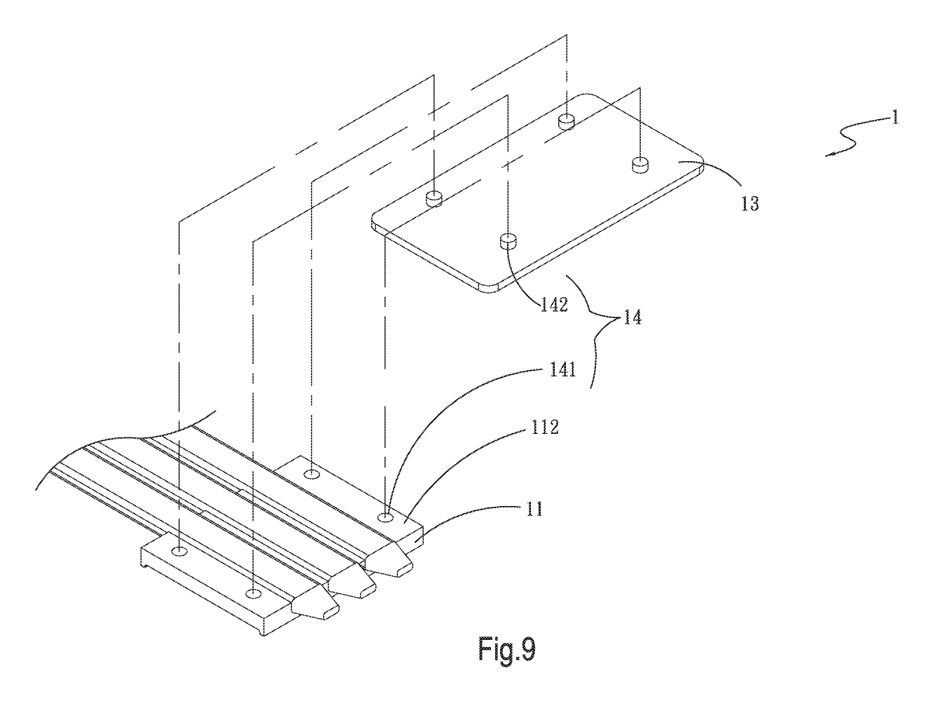

Please refer to FIG. 9. FIG. 9 is a perspective exploded view of a sixth embodiment of the thermal module structure of the present invention. The sixth embodiment is substantially identical to the fourth embodiment in structure and thus will not be repeatedly described hereinafter. The sixth embodiment is only different from the fourth embodiment in that the sixth embodiment further includes at least one assembling section 14. The assembling section 14 has a socket 141 and a boss 142 corresponding to the socket 141. The socket 141 is formed on the second side of the base 11. The boss 142 is disposed on one side of the board body 13, which side faces the second side 112 of the base 11. The boss 142 is fixedly inserted in the socket 141 to fix the board body 13 with the base 11.

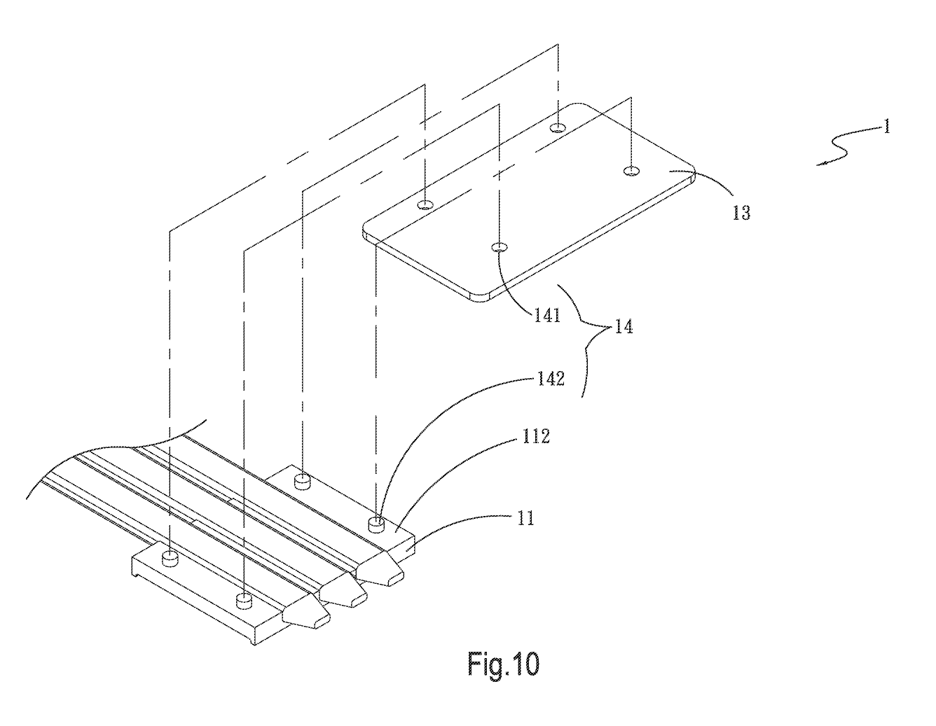

Please refer to FIG. 10. FIG. 10 is a perspective exploded view of a seventh embodiment of the thermal module structure of the present invention. The seventh embodiment is substantially identical to the fourth embodiment in structure and thus will not be repeatedly described hereinafter. The seventh embodiment is only different from the fourth embodiment in that the seventh embodiment further includes at least one assembling section 14. The assembling section 14 has a socket 141 and a boss 142 corresponding to the socket 141. The socket 141 is formed on one side of the board body 13, which side faces the second side 112 of the base 11. The boss 142 is disposed on the second side of the base 11. The boss 142 is fixedly inserted in the socket 141 to fix the board body 13 with the base 11.

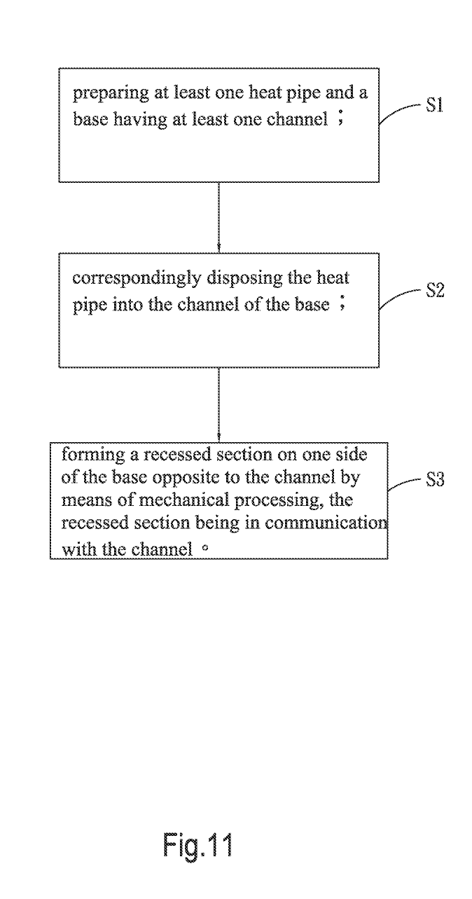

Please refer to FIG. 11, which is a flow chart of a first embodiment of the manufacturing method of the thermal module structure of the present invention. Also referring to FIGS. 1 and 2, the manufacturing method of the thermal module structure of the present invention includes steps of:

S1: preparing at least one heat pipe and a base having at least one channel, a heat pipe 12 and a base 11 with at least one channel (the first channel 113) being prepared;

S2: correspondingly disposing the heat pipe into the channel of the base, at least one end of the heat pipe 12 being correspondingly pressed into the channel (the first channel 113) of the base 11 to connect with the base 11; and

S3: forming a recessed section on one side of the base opposite to the channel by means of mechanical processing, the recessed section being in communication with the channel, a recessed section (the first recessed section 114) being formed on the other side of the base 11 opposite to the channel (the first channel 113) by means of mechanical processing, the recessed section (the first recessed section 114) being in communication with the channel (the first channel 113), a first face 121 of the heat pipe 12 being flush with a bottom of the channel (the first channel 114).

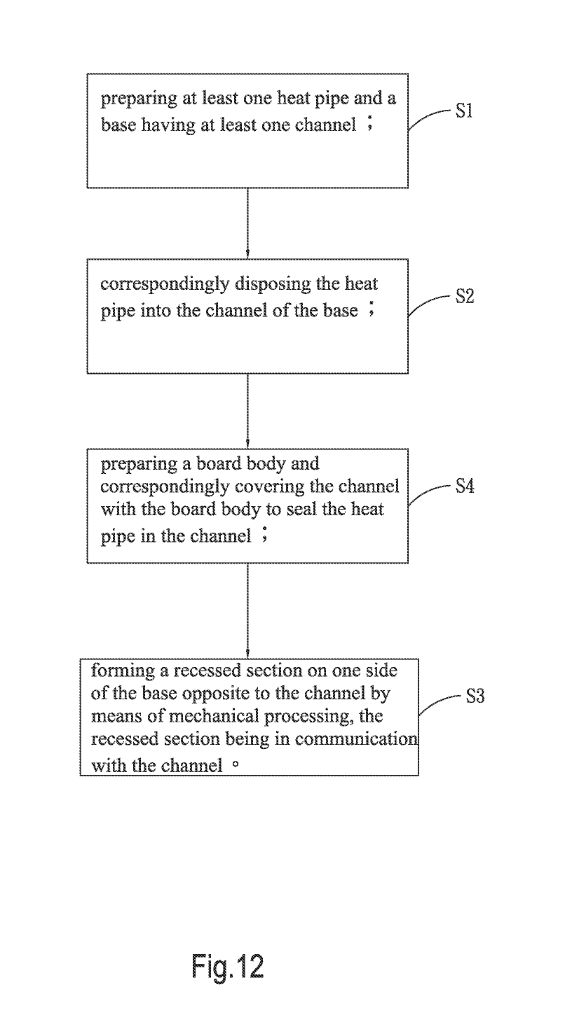

Please refer to FIG. 12, which is a flow chart of a second embodiment of the manufacturing method of the thermal module structure of the present invention. Also referring to FIGS. 1 to 6, the manufacturing method of the thermal module structure of the present invention includes steps of:

S1: preparing at least one heat pipe and a base having at least one channel;

S2: correspondingly disposing the heat pipe into the channel of the base; and

S3: forming a recessed section on one side of the base opposite to the channel by means of mechanical processing, the recessed section being in communication with the channel.

The second embodiment of the manufacturing method of the thermal module structure of the present invention is substantially identical to the first embodiment and thus will not be repeatedly described hereinafter. The second embodiment is different from the first embodiment in that after step S2 of correspondingly disposing the heat pipe into the channel of the base, the second embodiment further includes a step S4 of correspondingly covering the channel with a board body to seal the heat pipe in the channel. A board body 13 is connected to the side of the base 11 with the channel (the first channel 113) to correspondingly cover the channel (the first channel 113) and seal the heat pipe 12 in the channel (the first channel 113).

In the first and second embodiments, the mechanical processing is selected from a group consisting of milling and planning.

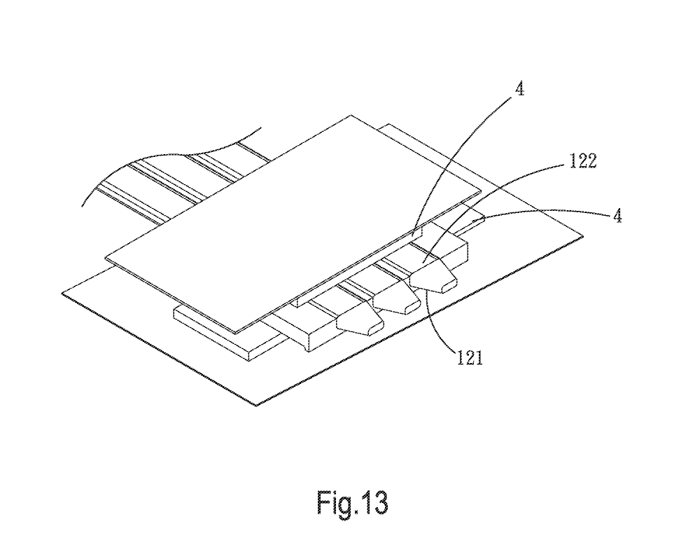

Please refer to FIG. 13. The base 11 of the thermal module structure 1 of the present invention is such designed that the first and second faces 121, 122 of the heat pipe 12 can both contact heat sources 4 to enhance heat dissipation efficiency. Accordingly, the thermal module structure can be more flexibly applied in a limited space.

The above embodiments are only used to illustrate the present invention, not intended to limit the scope thereof. It is understood that many changes and modifications of the above embodiments can be made without departing from the spirit of the present invention. The scope of the present invention is limited only by the appended claims.

1-7. (canceled)

8: A manufacturing method of a thermal module structure, comprising steps of:
preparing at least one heat pipe and a base having at least one channel;
correspondingly disposing the heat pipe into the channel of the base; and
forming a recessed section on one side of the base opposite to the channel by means of mechanical processing, the recessed section being in communication with the channel.

9: The manufacturing method of the thermal module structure as claimed in claim 8, wherein the mechanical processing is selected from a group consisting of milling and planning.

10: The manufacturing method of the thermal module structure as claimed in claim 8, after the step of correspondingly disposing the heat pipe into the channel of the base, further comprising a step of preparing a board body and correspondingly covering the channel with the board body to seal the heat pipe in the channel.
